(19) United States
(12) Patent Application Publication
(10) Pub. No.: US 2015/0226584 A1
(43) Pub. Date: Aug. 13, 2015

(54) SYSTEM FOR CATALOGING, MONITORING AND MAINTAINING MECHANICAL EQUIPMENT

(71) Applicant: Carl Bjornson, JR., Fall River, MA (US)

(72) Inventor: Carl Bjornson, JR., Fall River, MA (US)

(21) Appl. No.: 14/622,080

(22) Filed: Feb. 13, 2015

Related U.S. Application Data
(60) Provisional application No. 61/983,020, filed on Apr. 23, 2014.
(60) Provisional application No. 61/939,345, filed on Feb. 13, 2014.

(51) Int. Cl. G01D 9/00; G06Q 10/00

(52) U.S. Cl. CPC G01D 9/00; G06Q 10/20

(57) ABSTRACT

A computer based system is provided to log and track plant equipment. The system includes graphical surveying and cataloging for all plant positions that maintains images of the equipment and equipment data plates to allow easy reference and enhance communication between all parties involved when diagnostics and repairs must be made. The system provides a method for capturing data without the need for manual data entry or data entry personnel. Photos of equipment conditions are taken and loaded into categories and subcategories via a handheld photo application. Further, the system sets best practices automatically and as pictures are taken of the procedures the photos are made as entries into the database. The system further allows for automated billing and provides for valuable visual reporting of failures and work performed on equipment by third parties.

### CROSS-REFERENCE TO RELATED APPLICATIONS

This application is related to and claims priority from earlier filed U.S. Provisional Patent Application No. 61/983,020, filed Apr. 23, 2014, and earlier filed U.S. Provisional Application No. 61/939,345, filed Feb. 13, 2014.

### BACKGROUND OF THE INVENTION

The present invention relates to an innovative equipment management system. More specifically, the present invention provides a method and system for improved cataloging, monitoring and managing equipment through an innovative graphical dashboard interface to provide improved reliability and generate an auditable maintenance record for plant equipment.

Currently, there is no integrated system in place that allows real-time tracking of plant equipment assets that provides accurate maintenance logs, full and detailed equipment ordering and part data and communication with an equipment distributor or manufacturer directly for replacement parts, services and components. The repair and maintenance process is a manual process, prone to errors in communication and understanding between supplier and customer. In addition to communications problems, the different levels of experience among the sales engineers may lead to confusion when different sales engineers working for the same manufacturer make different recommendations based on their experience and understanding of the equipment.

Even if the selection process is accurate for given conditions, improper installation, operation or maintenance or repair of the pump and seals may degrade the operation. A lack of trained personnel often is a factor in improper installation, operation and maintenance of a mechanical seal or pump. In particular, it is possible that a sales engineer without proper training may select an improper seal.

Performance of equipment also should be monitored. To ensure that equipment is operating within an acceptable performance range, a disciplined, problem solving approach to pump and seal operation and maintenance is used. The process begins with a structured troubleshooting process for the equipment in the field. Visual observations of the equipment and seal, the seal support system, the piping system, etc. can provide important information and data for later analysis. It also may be possible to provide corrective actions for solving the problem or failure without shutting the equipment down.

In conjunction with field troubleshooting it is important to maintain a repair history for the equipment. This information can provide data on changing or recurring conditions that have negatively impacted reliability. Because the configuration of the processing plant changes often, it is difficult to maintain data about the configuration of the plant up to date. Modifications to equipment and changes to process fluids commonly occur. Processing plant reliability managers commonly do not have a convenient and timely method of determining the current state of equipment in a plant. In addition, because of the lack of information regarding the current state of equipment within the plant, the plant maintenance or reliability manager often has inadequate information for cost and failure analysis. Life cycle costs (LCC) and mean time between failure (MTBF) are commonly used metrics to determine the efficiency and productivity of plant equipment. LCC involves tracking the costs associated with equipment over a given period of time. MTBF involves tracking the time between failures of the particular piece of machinery. Without accurate up to date information on the current state of a piece of equipment, however, these measures cannot be computed accurately.

Further tracking of the operational history of the equipment may reveal operating conditions that are incompatible with a seal or pump or other equipment. For example, operating conditions such as pressure, environmental or process fluid temperatures, etc. may deviate significantly from normal operating conditions. By analyzing these deviations from normal operating conditions, the cause of a failure may be determined to have been due to the operating conditions and not due to a mechanical failure. However, the data required to undertake such a structured analysis is often not recorded centrally and is not at the disposal of the plant staff. Since maintenance records on plant equipment is poorly maintained if at all, the equipment is only addressed when it fails. When the equipment fails, the part that fails is simply replaced often using legacy part numbers. In such a situation the wrong parts are often used. Further, chronic failure patterns are often missed. While the seal of a pump, for example, may be replaced multiple times, because of the lack of maintenance record on the equipment the fact that the wrong seal is being installed each time or that one of the bearings is failing causing pump eccentricity or vibration is being missed and sets up the facility for a cycle of failure.

The current gold standard provides for a costly database arrangement that requires initial set up and data entry. The system is typically stand alone and is only as good as the data that is entered and only remains viable if the data is regularly audited and updated. The problem is that such systems are relatively high in cost and their standalone nature makes them labor intensive for implementation and regular updating. As a result such systems have only been adopted primarily by the top tier, roughly 1/3, of facilities.

This cycle of poor record keeping and lack of system updating is continually reinforced by lack of institutional knowledge of the equipment, legacy ordering of parts with the wrong or prior part number and the lack of best practices diagnostic information. As facilities grow and the number of pieces of mechanical equipment in service expands dramatically, plants hire full reliability staffs. In these cases they employ reliability engineers, technicians, data entry personnel, and equipment experts for seals, pumps and bearings as needed. As a result, the maintenance overhead rises dramatically.

Further, after equipment is sold, manufacturers and distributors desire to capture the aftermarket service business for the piece of equipment from the time it is commissioned (put in service) to the time it is retired (discarded). In many cases, equipment is sold at cost or with small margins, in hopes that the manufacturer and distributor will capture the repair and service revenues for the life of the equipment. Most manufacturers and distributors would like to monetize and capture this lucrative revenue stream, but none of the current equipment management systems allow a connection that facilitates such event capture and monetization.

In addition manufacturers and distributors many times do not know where their equipment is installed, in what plants, and in what applications. They lack performance information on their equipment and competitor's equipment which would be very valuable. They do not know how their equipment is performing, when failures occur and many times lose out on the lucrative aftermarket revenue streams mentioned above.

Even with large and prohibitively expensive staff to ensure reliability, the issues identified above are not resolved. This is because there still is not an integrated system that tracks all mechanical plant equipment. Accordingly, there is a need for a system to easily log and track all plant equipment in a single and organized fashion. Further there is a need for a system that integrates plant equipment inventory, maintenance history and technical data in a single solution that assists in diagnosing failure conditions for the equipment and also communicates with available manufacturer data and equipment distributors or manufacturers directly in a manner that enhances the equipment management process and greatly increases equipment reliability.

There is therefore a need for a method and system for improved cataloging, monitoring and managing equipment through an innovative graphical dashboard interface to provide improved reliability and generate an auditable maintenance record for plant equipment.

There is a further need for a method and system for improved cataloging, monitoring and managing equipment in a manner that increases accountability relating to the life cycle maintenance of the equipment.

There is still a further need for a method and system for improved cataloging, monitoring and managing equipment in a manner that facilitates visual diagnosing repair reporting and maintenance records in order to identify failure paths and provide corrective actions to prevent reoccurring failures.

There is still a further need for a method and system for improved cataloging, monitoring and managing equipment through an innovative graphical dashboard interface to provide improved reliability and generate an auditable maintenance record for plant equipment that operates in a broad based computing environment eliminating the traditional standalone database model used in the industry.

Finally there is a need for a method and system for improved cataloging, monitoring and managing equipment that operates in real time with vendors, suppliers and service providers and manufacturers enhancing communications and providing both notifications of upcoming failures and integrates to monetize equipment reliability functions as the process unfolds.

### BRIEF SUMMARY OF THE INVENTION

In this regard, the present invention provides for a method and system for improved cataloging, surveying, monitoring and managing equipment through an innovative graphical dashboard interface to facilitate improved reliability and create an auditable maintenance record for plant equipment.

In one aspect of the invention a computer based system is provided to log and track all plant equipment. The system includes graphical surveying and cataloging for all plant positions that maintains images of the equipment and equipment data plates to allow easy reference and enhance communication between all parties involved when diagnostics and repairs must be made. The system provides a method for capturing data without the need for manual data entry or data entry personnel. Photos of equipment conditions are taken and loaded into categories and subcategories via a handheld photo application. Further, the system sets best practices automatically and as pictures are taken of the procedures the photos are made as entries into the database, for example that a vibration check has been performed. This allows for automated billing and provides for valuable visual reporting of failures and work performed on equipment by third parties. As photos are captured information is automatically routed to appropriate performance database location so that info is stored (e.g. to a plant position #) and presented in usable form for increased plant performance.

In another aspect of the present invention, the system is integrated either locally or via a global computer network to provide best practices data related to each piece of equipment in each position. In this manner the system provides staff with access to graphic based trouble shooting information and detailed maintenance best practices recommendations for maintaining, diagnosing, repairing and operating the equipment.

In another aspect of the present invention, provides a visual failure diagnosis system wherein uses can search all of the visually diagnosed failure modes of the equipment within the system. Based on a wide database of diagnostic information data points relating to the equipment the failure modes are analyzed to provide a best estimate probability of the item or items that caused the current failure. Such failure modes can be user controlled to show any level of failure probability desired. For example the user can limit repairs to only item that fall in the higher level 50% percentile failure mode or can view all possible failure causes.

In another aspect of the present invention, the system provides diagnostic repair recommendations including replacement parts needed. Further, should the user wish the data is forwarded to the distributor to initiate a replacement part order, a service call or if needed an equipment replacement. The system is structured to include a distributor or manufacturer and plant database communicating with each other. This provides a way for distributors and/or manufacturers to get valuable information on plants and for manufacturers to get valuable information on distributors. It also provides visibility into the plant to facilitate lead/sales generation. When diagnostics and/or any type of failure analysis are entered to the system it generates leads for distributors. This allows the ability to document and charge for distributor consulting services and or field services.

Depending on party performing services it creates an opportunity for monetizing the equipment reliability process by generating automated billing and allows for invoicing of services. Clearly different apps, rights, access and data presented may be different depending on the party accessing the system. Similarly, the same app may be used to serve up different data based on the account accessing the app. This will allow limitations on scope of data, equipment, etc. that various accessing parties are allowed to view. It creates three potential revenue paths where it can implement pay per click for uploading photos, performing diagnostics and/or performing pest practice procedures. At the time of the services the party that carries out the service is logged with a time and date stamp. The charges also could be accrued on a per app use basis. Ultimately, an automated system tracks all of the relevant generation of billing and allows for a downloaded report of billing and services.

The system identifies persons who perform services and allows for tracking and accountability of work performed by parties. It also identifies who performed best practices fieldwork, whether it is plant personnel or distributor service personnel, and in turn provides for valuable reporting. It is anticipated that different apps will be employed where users have different rights, access to different data and access to different/limited equipment as needed. This allows access to be controlled on a party by party and user by user basis.

Movies can be attached for the recording and diagnoses of sounds and/or leak patterns as needed. This may allow the diagnosis of issues such as bearings, vibration, pump cavitation, etc.

Further photos can be flagged so that images can be shared or uploaded into forums for community based assistance and/or diagnosis.

Finally, the system tracks and maintains a repair history/audit log of actions taken on the system. This allows the tracking of chronic problems to identify poor maintenance repair and operating practices, misdiagnosis of equipment failure of the need for equipment replacement.

The system is structured to operate on a visual basis in that the data in the system is populated using photographs. Each equipment position is created and a user attaches a photograph of the equipment and pictures of the motor data plates. Further as maintenance is performed, test results can be photographed and attached to each position. For example, display screens showing vibration test results can be photographed and placed in connection with the equipment record. Similarly, maintenance and repair processes and parts replaced or reused are photographed and attached to the record.

The system of the present invention provides for an automated equipment registration feature which allows manufacturers and distributors to pre-populate equipment information (attachments, instructions) for equipment as it leaves manufacturers factories and distributors locations. This feature facilitates (makes it easy for plants to register) the registration of equipment in the system enabling manufacturers and distributors to capture the repair and service spend for their equipment for its life cycle. Also, a Lifecycle Reliability Registration Feature is tied to a system with apps for performing and tracking services.

It is therefore an object of the present invention to provide a method and system for improved cataloging, monitoring and managing equipment through an innovative graphical dashboard interface to provide improved reliability and generate an auditable maintenance record for plant equipment.

It is a further object of the present invention to provide a method and system for improved cataloging, monitoring and managing equipment in a manner that increases accountability relating to the life cycle maintenance of the equipment.

It is another object of the present invention to provide a method and system for improved cataloging, monitoring and managing equipment in a manner that facilitates visual diagnosing repair reporting and maintenance records in order to identify failure paths and provide corrective actions to prevent reoccurring failures.

It is another object of the present invention to provide a method and system for improved cataloging, monitoring and managing equipment through an innovative graphical dashboard interface to provide improved reliability and generate an auditable maintenance record for plant equipment that operates in a broad based computing environment eliminating the traditional standalone database model used in the industry.

Finally, it is an object of the present invention to provide a method and system for improved cataloging, monitoring and managing equipment that operates in real time with vendors, suppliers and service providers to provide both notifications of upcoming failures and integrates to monetize equipment reliability functions as the process unfolds.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be made to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a schematic diagram of the system of the present invention;

FIG. 2 is an illustration of the visual data entry of an equipment position;

FIG. 3 is an illustration of the relationship between the database structure and the equipment position;

FIG. 4 is an additional illustration of the visual data entry of an equipment position;

FIGS. 4-6 are an illustration of the visual data entry of best practices and maintenance data relating to an equipment position;

FIGS. 9-11 illustrate a visual failure diagnosis process; and

FIG. 12 illustrates the attaching and tracking of a repair process to the equipment position.

### DETAILED DESCRIPTION OF THE INVENTION

As stated above, the present invention provides a new method and system for improved cataloging, surveying, monitoring and managing equipment through an innovative graphical dashboard interface to facilitate improved reliability and an auditable maintenance record for plant equipment.

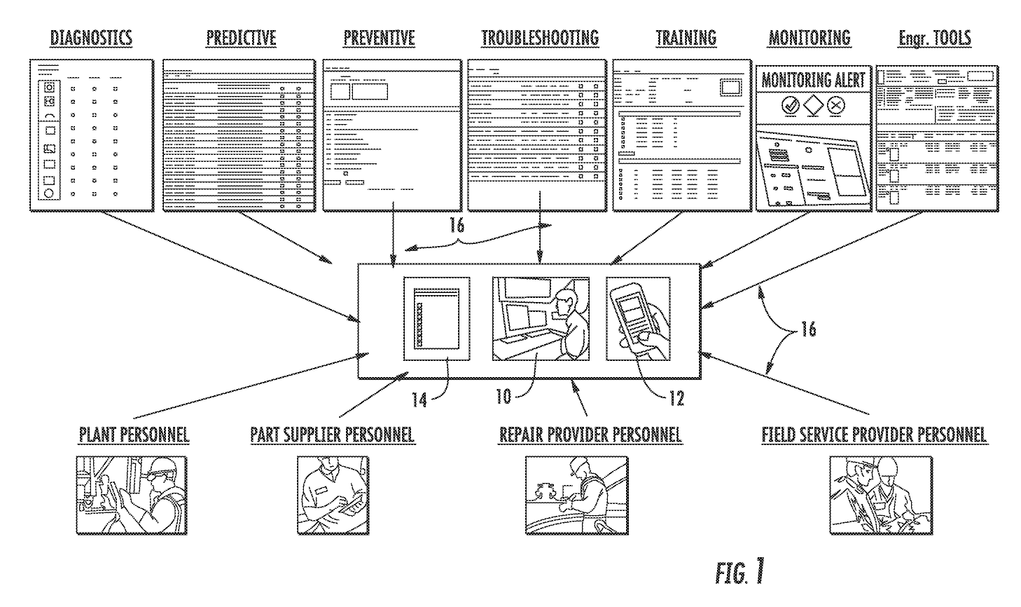

Generally, the method and system of the present invention is a computer based system that logs and tracks all plant equipment. The system illustrated at FIG. 1 is a structured database that can be implemented as is known on a computer 10, a mobile computing device 12 or any other access portal 14 via a cloud based solution connected to a global communications network 16. The structure provides for the integration of all of the tools necessary for improved cataloging, surveying, monitoring and managing equipment such as diagnostics tools relating to prediction, prevention and troubleshooting failure modes, training tools and, monitoring tools. Further the system integrates reporting and interactivity between the plant personnel, part suppliers, repair service providers and field service providers all in a tracked and auditable real time structure.

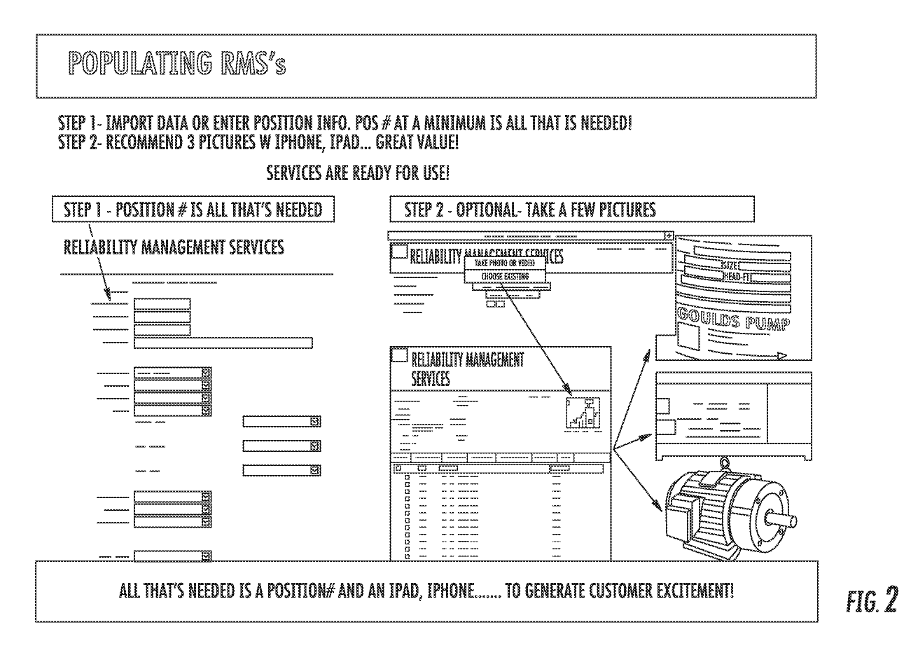

In connection with the portal, the system as shown in FIGS. 2, 3 and 4 provides a graphical surveying and cataloging for all plant positions that maintains images of the equipment and equipment data plates to allow easy reference and enhance communication between all parties involved when diagnostics and repairs must be made. The entire system provides for visual recordkeeping rather than time consuming data entry. In this manner, operations personnel are more likely to engage with the system and enter the needed data because the process is much less burdensome than the traditional data entry requirements. In addition, suppliers and service providers are more likely to engage with the system and enter the needed data as they can monetize this activity and also position themselves to lock up the future parts and services spend for the equipment as a result.

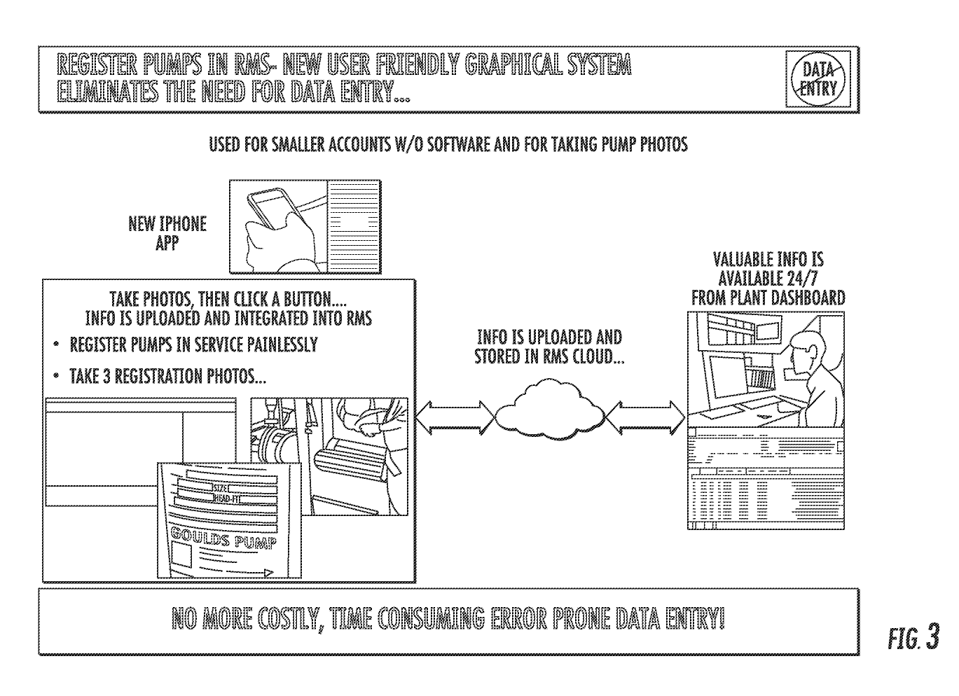

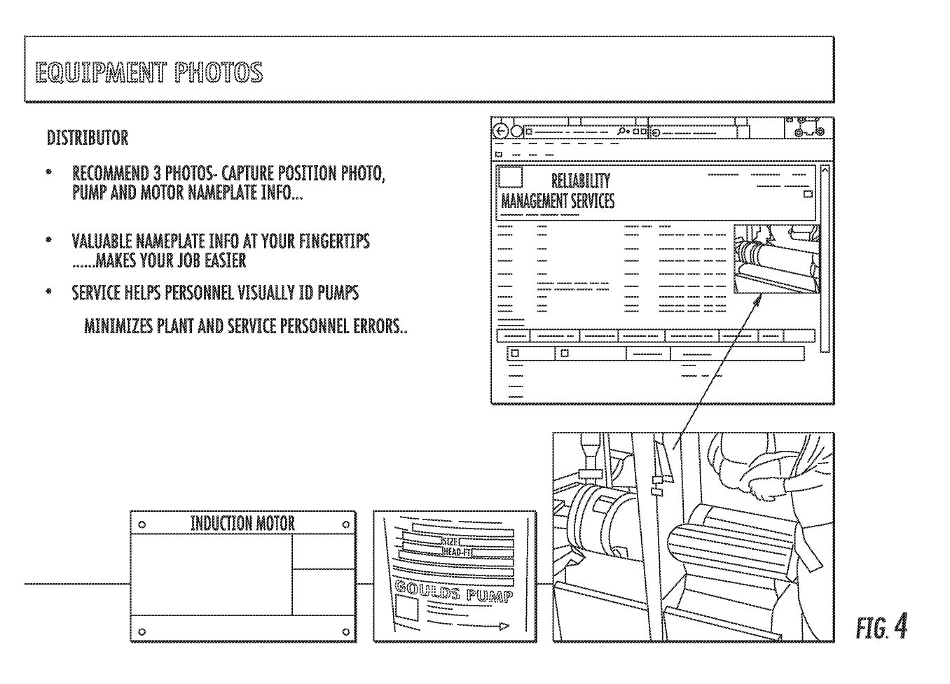

As can be seen at FIG. 2, the system provides a method for capturing data without the need for manual data entry or data entry personnel. A position is established within the system, the position becoming the record page for the piece of equipment of interest. With the position established, the system operator then takes photos of the equipment and loads the photos into categories and subcategories associated with that position via a handheld photo application or by uploading previously taken photographs via a computer terminal. As seen in FIG. 3, the equipment position is then uploaded and stored into the application in the cloud enabled storage. As photos are captured information is automatically routed to appropriate performance database location so that info is stored (e.g. to a plant position #) and presented in usable form for increased plant performance. This information is then readily available to all that have access to the plant system.

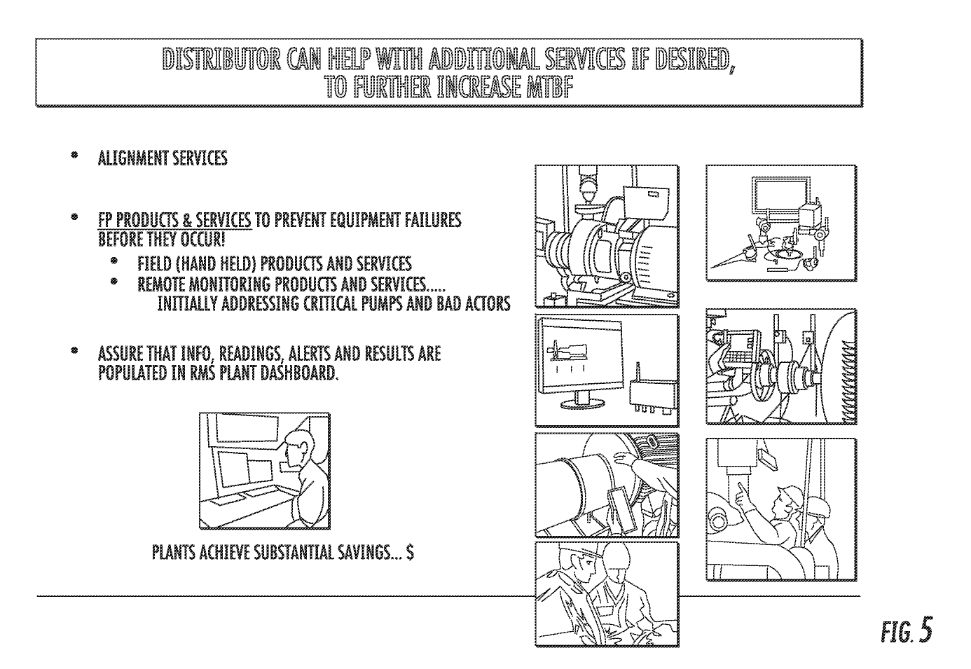

FIG. 4 illustrates that it is preferred that as a minimum images of the equipment and the equipment data plate(s) are photographed and registered to the position. This places all of the critical equipment nameplate data in a position for all to access. By using photographs the chance for data entry error is greatly reduced. This allows service personnel to visually identify the equipment and minimizes mistakes being made due to data entry errors of mistaken equipment identification.

It is another aspect of the disclosure to provide a system whereby plant personnel and all suppliers of products and services are held accountable for proper maintenance and exercising best practices to maximize equipment uptime. In this regard the system provides for real time capture of visual repair reporting and visual analysis of any and all MRO activity reporting. Further the system date and party stamps all maintenance, repair and operations activity and captures the record graphically with images in ascending time chronology. This creates auditable maintenance records for plant equipment.

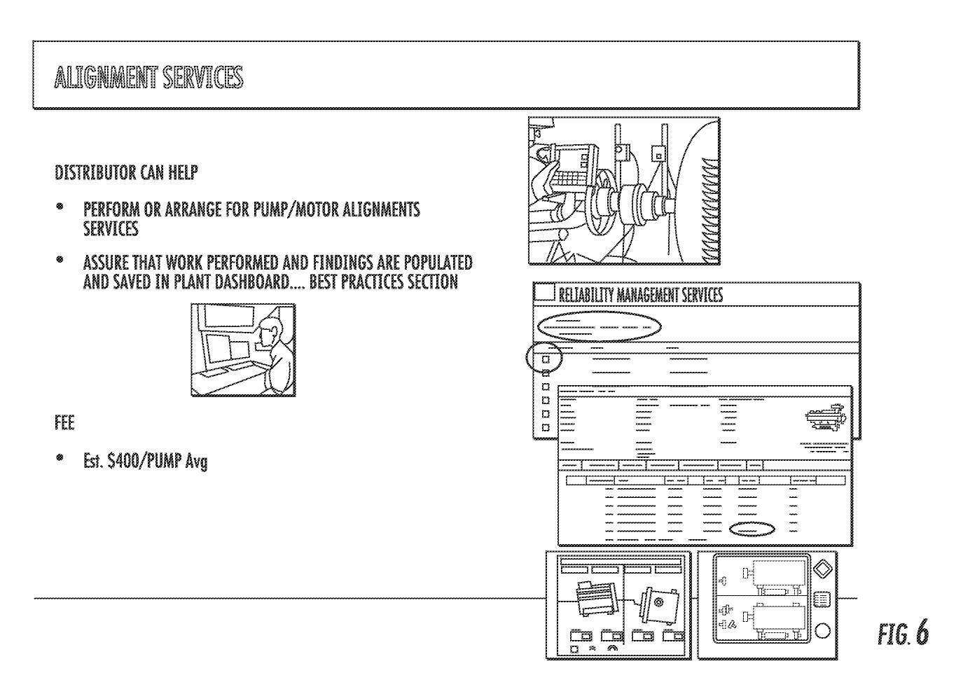

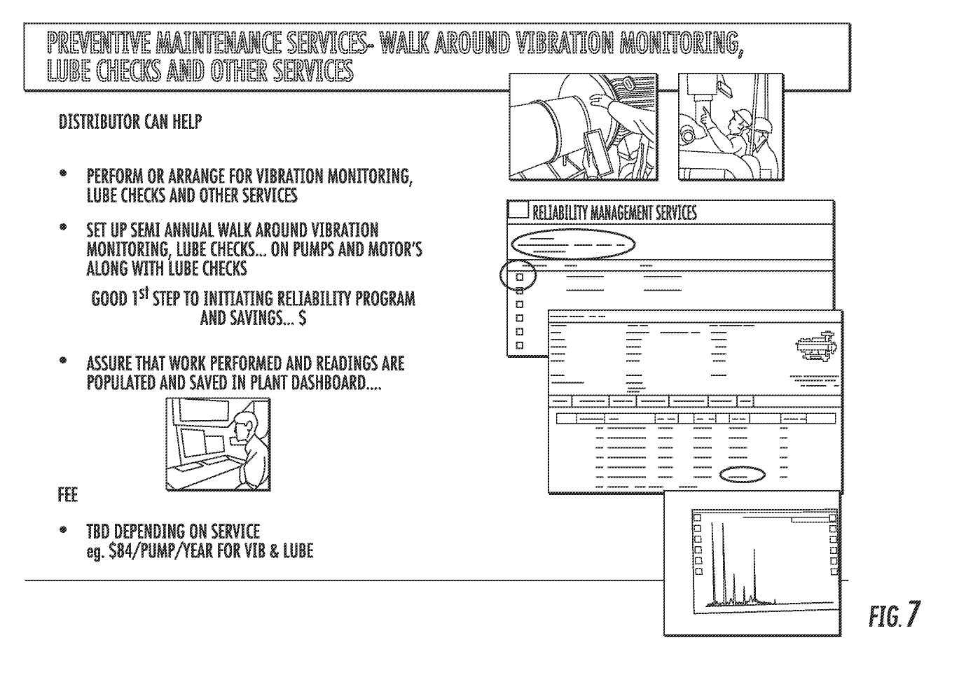

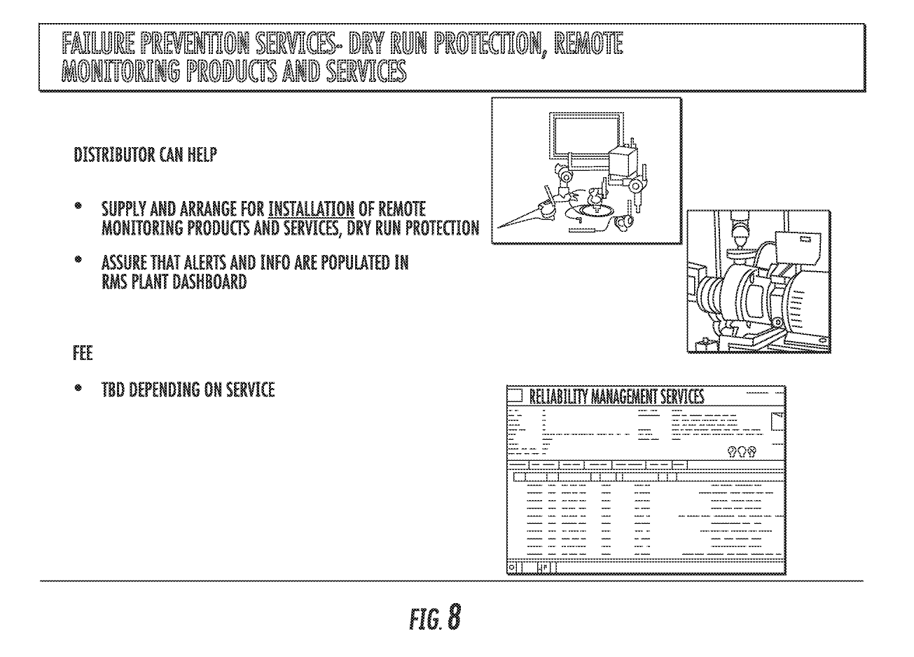

In another aspect of the present invention, the system is integrated either locally or via a global computer network to provide best practices data related to each piece of equipment in each position. In this manner the system provides staff with access to graphic based trouble shooting information and detailed maintenance best practices recommendations for maintaining and diagnosing the equipment. FIGS. 5-8 illustrates how the system the system sets best practices automatically and assigns them to each equipment position. This insures that all the required maintenance schedules, recommended testing and necessary inspections are pre-populated into the system as each of the pieces of equipment is attached to the cloud record. For example, FIG. 6 illustrates the performance of a motor/pump alignment service. The pest practice reminder is issued. Then a technician performs the alignment service. The test process and result is captured in photographs and attached to the log associated with the equipment position. This creates a real time verification of who performed the service, the process undertaken and the result of the service performed.

Similarly, the system, as shown at FIG. 7 allows for scheduling of various service functions such as vibration and lubrication checks. As each task is performed, pictures are taken of the procedures and the photos are made as entries into the database, for example that a vibration check has been performed. In addition to creating a maintenance record of the equipment position, this allows for automated billing and provides for valuable visual reporting of failures and work performed on equipment by third parties. Further, as indicated at FIG. 8, this allows a distributor to supply and arrange for remote monitoring services that interconnect with the system and provide relevant monitoring information to the integrated equipment position record.

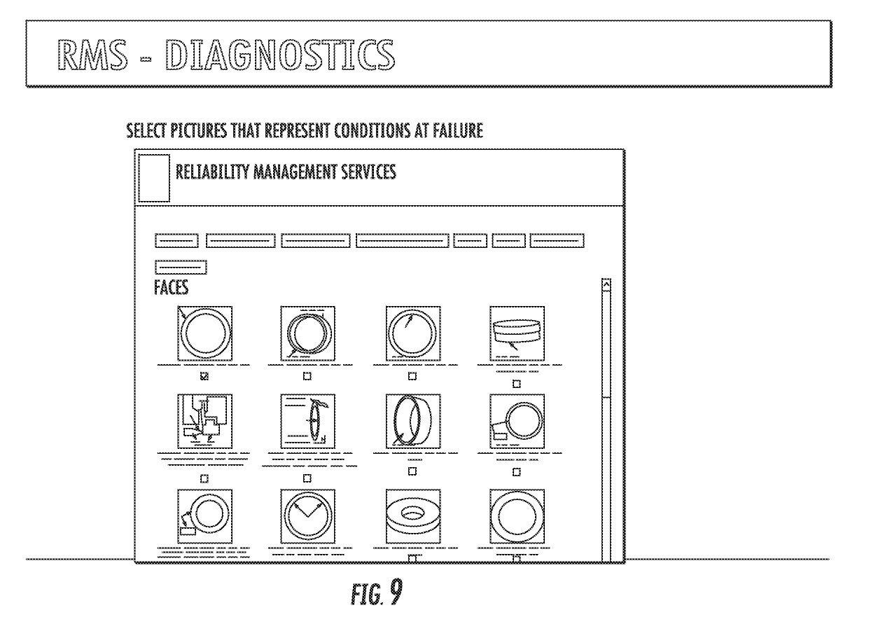

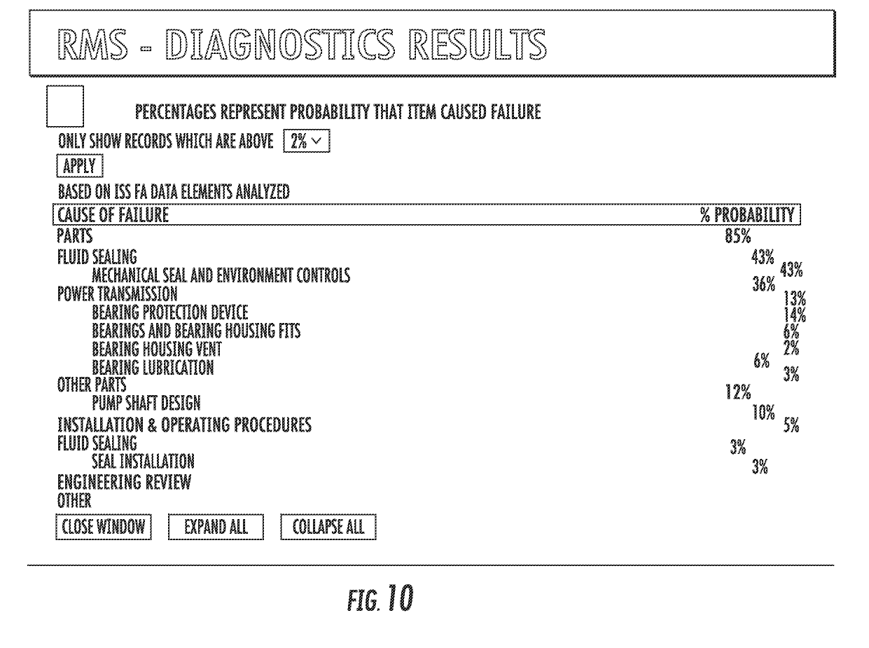

In another aspect of the present invention, the system facilitates visual diagnosis of equipment failures and a visual record of repair history of the equipment. FIGS. 9-12 provide an illustration of the operation of the system for visual diagnosis of the equipment failure modes. As failure conditions are encountered with equipment positions, the staff inputs all of the visually diagnosed failure modes of the equipment into the system as illustrated at FIG. 9. Based on a wide database of visual diagnostic information data points relating to the equipment the user selects the failure modes identified with their equipment. The system, as shown at FIG. 10 then utilizes the various identified failure modes to perform an analysis that generates a best estimate probability of the item or items that caused the current failure. Such failure modes can be user controlled to show any level of failure probability desired. For example the user can limit repairs to only item that fall in the higher level 50% percentile failure mode or can view all possible failure causes.

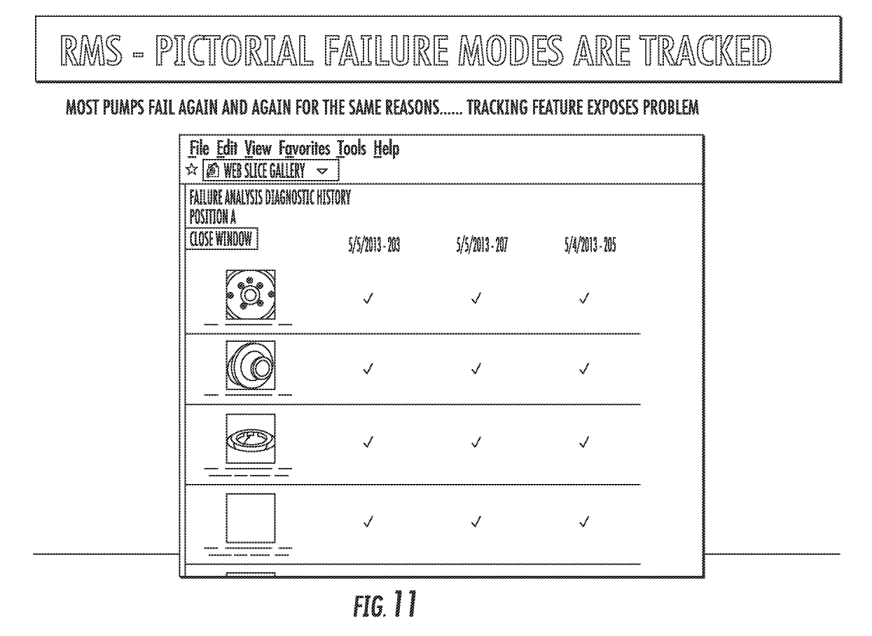

Given the identification of failure mode and the various possible causes, the user can then systematically evaluate the equipment to locate the failure cause and effect service and repair. As shown at FIG. 11, a record of the maintenance process, failure mode, replaced component and personnel making the diagnosis and repair are all tracked and attached to the record associated with the equipment location. This further ads to the auditable service record and provides a strong tool for the life cycle analysis of the equipment.

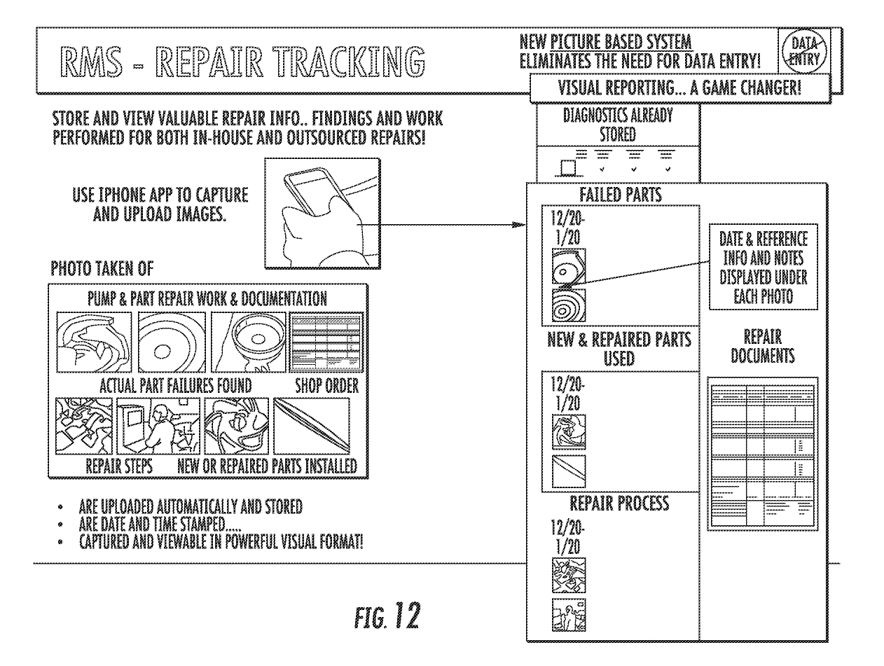

More importantly, as illustrated at FIG. 12, the system provides diagnostic repair recommendations including replacement parts needed. Further, should the user wish the data is forwarded to the distributor/supplier to initiate a replacement part order, a service call or if needed an equipment replacement. The system is structured to include a distributor and plant database communicating with each other. This provides a way for distributors and/or manufacturers to get valuable information on plants and for manufacturers to get valuable information on distributors. It also provides visibility into the plant to facilitate lead/sales generation. When diagnostics and/or any type of failure analysis are entered to the system it generates leads for distributors. This allows the ability to document and charge for distributor consulting services and or field services.

Depending on party performing services it creates automated billing and allows for invoicing of services. Clearly different apps, rights, access and data presented may be different depending on the party accessing the system. Similarly, the same app may be used to serve up different data based on the account accessing the app. This will allow limitations on scope of data, equipment, etc. that various accessing parties are allowed to view.

The system creates several potential revenue paths where it can implement pay per click monetization for uploading photos into each of the equipment record. Alternately, per use fees can be assigned for performing diagnostics and/or performing pest practice procedures. At the time of the services the party that carries out the service is logged with a time and date stamp. The charges also could be accrued on a per app use basis. Ultimately, an automated system tracks all of the relevant generation of billing and allows for a downloaded report of billing and services.

The system identifies persons who perform services and allows for tracking and accountability of work performed by parties. It also identifies who performed best practices fieldwork whether it is plant personnel or distributor service personnel which provides for valuable reporting. It is anticipated that different apps will be employed where users have different rights and access to different data. This allows access to be controlled on a party by party and user by user basis. This also lets account access to different equipment to be limited as needed.

Movies can be attached for the recording and diagnoses of sounds and/or leak patterns as needed. This may allow the diagnosis of issues such as bearings, vibration, pump cavitation, etc.

Further photos can be flagged so that images can be shared or uploaded into forums for community based assistance and/or diagnosis.

Finally, the system tracks and maintains a repair history/audit log of actions taken on the system. This allows the tracking of chronic problems to identify poor maintenance practices, misdiagnosis of equipment failure of the need for equipment replacement.

It can therefore be seen that the present invention provides a method and system for improved cataloging, monitoring and managing equipment through an innovative graphical dashboard interface to provide improved reliability and generate an auditable maintenance record for plant equipment in a manner that increases accountability relating to the life cycle maintenance of the equipment. Further the system provides visual diagnosing repair reporting and maintenance records in order to identify failure paths and provide corrective actions to prevent reoccurring failures through an innovative graphical dashboard interface to provide improved reliability and generate an auditable maintenance record for plant equipment that operates in a broad based computing environment eliminating the traditional standalone database model used in the industry. Finally, the system operates in real time with vendors, suppliers and service providers to provide both notifications of upcoming failures and integrates to monetize equipment reliability functions as the process unfolds. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for cataloging, surveying, monitoring and managing a plurality of equipment, comprising:
a centralized database accessible via a plurality of access devices;
a plurality of equipment records stores within said database; and
a visual data entry system wherein identifying photographs of each piece of equipment to be catalogued are entered and assigned to corresponding equipment records,
wherein said system accesses relevant data relating to each piece of catalogued equipment and assigns said relevant data to said corresponding equipment records.

2. The system of claim 1, wherein said relevant data includes maintenance instructions, best practices instructions, parts lists and/or diagnostics information.

3. The system of claim 1, wherein said system is accessed by plant personnel where the equipment is installed, equipment vendors and service providers in a collaborative manner.

4. The system of claim 1, further comprising:
an auditable maintenance record for each piece of cataloged equipment that includes at least one photograph of the repair made, images of the repair operations and date, time and responsible party listings.

5. The system of claim 1, further comprising:
a visual diagnosis record relating to each piece of equipment to allow identification of root causes related to visually identified failure symptoms.

6. The system of claim 5, wherein said visual diagnosis record provides a listing of failure causes that relate to visually identified part failures.

7. The system of claim 6, wherein said listing of failure causes is listed in order based on probability that said cause is likely to have caused a failure of interest.

8. The system of claim 5, further comprising:
a real time reporting and notification module that provides advance notice to vendors and service providers of potential failure issues.

9. The system of claim 8, further comprising:
an auditable maintenance record for each piece of cataloged equipment that includes at least one photograph of the repair made, images of the repair operations and date, time and responsible party listings.

10. A system for structuring communications between plant personnel, vendors and service providers regarding a plurality of equipment, comprising:
a centralized database accessible via a plurality of access devices;
a plurality of equipment records stores within said database; and
a visual data entry system wherein identifying photographs of each piece of equipment to be catalogued are entered and assigned to corresponding equipment records,
wherein said system accesses relevant data relating to each piece of catalogued equipment and assigns said relevant data to said corresponding equipment records,
wherein said system is accessed by plant personnel where the equipment is installed, equipment vendors and service providers in a collaborative manner to create an auditable maintenance record for each piece of cataloged equipment that includes at least one photograph of the repair made, images of the repair operations and date, time and responsible party listings.

11. The system of claim 10, wherein said relevant data includes maintenance instructions, best practices instructions, parts lists and/or diagnostics information.

12. The system of claim 10, further comprising:
a visual diagnosis record relating to each piece of equipment to allow identification of root causes related to visually identified failure symptoms.

13. The system of claim 12, wherein said visual diagnosis record provides a listing of failure causes that relate to visually identified part failures.

14. The system of claim 13, wherein said listing of failure causes is listed in order based on probability that said cause is likely to have caused a failure of interest.

15. The system of claim 12, further comprising:
a real time reporting and notification module that provides advance notice to vendors and service providers of potential failure issues.
